(19) United States
(12) Patent Application Publication
(10) Pub. No.: US 2008/0104024 A1
(43) Pub. Date: May 1, 2008

(54) Highlighting results in the results page based on levels of trust

(76) Inventors: Amit Kumar, San Jose, CA (US); Priyank S. Garg, San Jose, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/586,985

(22) Filed: Oct. 25, 2006

(51) Int. Cl. G06F 17/30; G06F 7/00; G06F 17/00

(52) U.S. Cl. 707/3; 707/7; 715/273; 715/255

(57) ABSTRACT

A technique is provided for highlighting specific website information in a results page of a query that is submitted by a user. A plurality of webpages is identified that each satisfies the query. A subset of the plurality of webpages is identified based on Web activity of the user or another user in a group with which the user is associated. Data, including a plurality of references and particular instructions, is sent to the user. Each reference of the plurality of references corresponds to a separate webpage of the plurality of webpages. A particular subset of the plurality of references corresponds to the subset of the plurality of webpages. The particular instructions cause each reference of the particular subset, when displayed, to be visually distinguished from references that are not in the subset.

### FIELD OF THE INVENTION

The present invention relates generally to Web queries, and more specifically, to providing a results page that is based on a Web query and that highlights certain results based on a level of trust of each highlighted result.

### BACKGROUND

In a typical Web search scenario, a user enters a query that comprises one or more terms (each of which may or may not be defined words). The query is applied to a search engine database which returns results that satisfy one or more terms of the query. For example, based on a query of “sports”, the search engine may return links to popular sports websites and/or links to webpages that contain the word “sports” most, etc. The links may be ordered based on, for example, a projected relevance to the terms in the query. Other factors may be taken into account to determine the order of the links that are displayed in the results page.

However, current search engines do not take into account certain information about the webpages that correspond to the links in the results page. Such additional information may be helpful to the user in determining whether some of the webpages may be trusted by, or be even more relevant to, the user.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an example of how some references to webpages displayed in a search engine results page (SERP) may be visually distinguished from other references displayed in the SERP, according to an embodiment of the invention.

FIG. 2 is a flow diagram that illustrates how ownership of websites by a user or another user in a group with which the user is associated may be used to visually distinguish references to webpages in a SERP presented to the user, according to an embodiment of the invention;

FIG. 3 is a flow diagram that illustrates an example of how results of a Web query may be displayed to a user based on the Web activity of the user or another user in a group with which the user is associated, according to an embodiment of the invention;

FIG. 4 is a flow diagram that illustrates another example of how results of a Web query may be displayed to a user based on the Web activity of the user or another user in a group with which the user is associated, according to an embodiment of the invention;

FIG. 5 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

A search engine results page (SERP) may provide, to a particular user, more information than simply the links (i.e., references) to identified relevant webpages. Information about the Web activity (defined below) of the particular user and/or the Web activity of any user in a group with which the particular user is associated may be used to distinguish some links from others in the SERP. Such Web activity may include (1) bookmarking or tagging Uniform Resource Locators (URLs), and (2) visiting webpages and/or websites.

For example, user A belongs to a user group M and submits a query “sports cricket”. User group M includes a user B who frequently tags webpages of the website “cricket.com”. Based on the query, the SERP lists “cricket.com” as the fifth most relevant webpage. However, because user A is associated, via user group M, with user B who frequently tags webpages of the “cricket.com” website, user A may be interested in knowing that the listed webpage is trusted by other users that user A presumably trusts (i.e., via the user group association). Thus, the SERP may highlight the reference to “cricket.com” using, for example, an icon or a different background color that visually distinguishes “cricket.com” from other references displayed in the SERP.

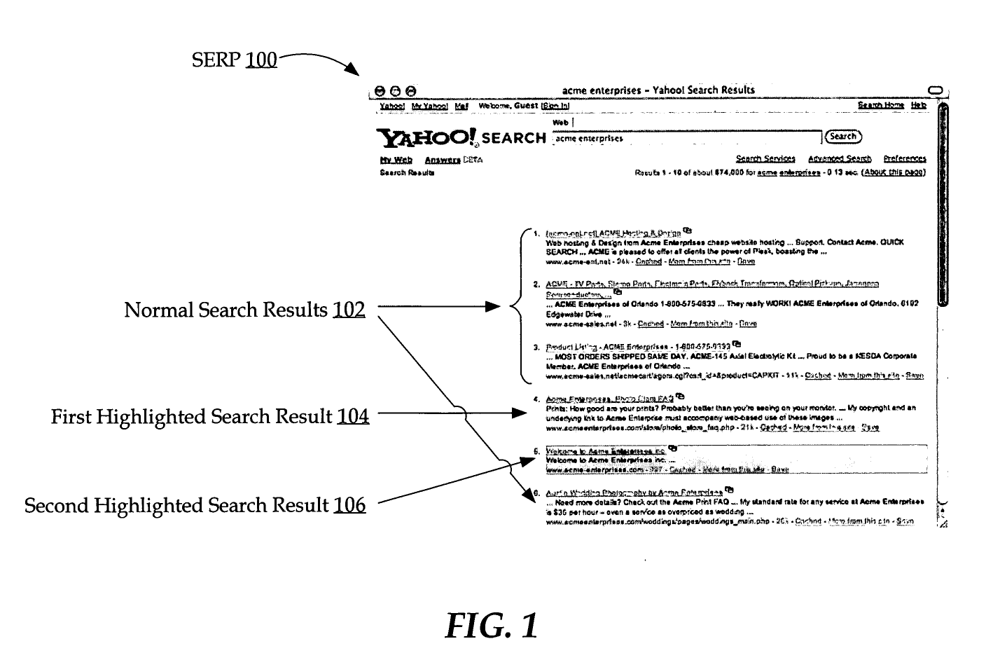

FIG. 1 is an example of how some references to webpages displayed in a SERP 100 may be visually distinguished from other references displayed in SERP 100, according to an embodiment of the invention. In this example, SERP 100 indicates that the submitted query is “acme enterprises”. SERP 100 displays references to webpages that the search engine, which produced SERP 100, determines are relevant to the submitted query. At least four of the references displayed in SERP 100 are “normal” search results 102. Reference may also refer to resources other than webpages, such as documents, images, and video.

A first highlighted search result 104 is a reference that is visually distinguishable from other references that are displayed in SERP 100. In this example, the first highlighted search result 104 is associated with a background color that is different than the background color associated with any reference in the normal search results 102. The background color of a reference may indicate, for example, a certain level of trustworthiness or extra relevance given to the webpage that corresponds to the reference. The certain level of trustworthiness or extra relevance may either be implicit or explicit based on activities of (a) the user, or (b) other users of a user group with which the user is associated. One or more other references that are displayed in SERP 100 may share the same background color, which may indicate, for example, a similar level of trust.

A second highlighted search result 106 is a reference that is visually distinguished by a background color that is different than (a) the background color of any reference in the normal search results 102, and (b) the background color of the reference of the first highlighted search result 104. The different background color of the second highlighted search result 106 may indicate that the corresponding webpage is associated with a level of trustworthiness that is different than the level of trustworthiness associated with the webpage that corresponds to the first highlighted search result 104, for example.

In one approach, the distinguished search results are visually distinguished using an icon or any other mechanism to visually distinguish one reference in a SERP from other references in the SERP.

### Definitions

A “website” is a collection of webpages, typically common to a particular domain name or subdomain on the Internet. A website is owned and/or managed by a single entity, such as an individual, a partnership, or a company. For example, the website (and each of the webpages on the same server or set of servers) accessible at http://cnn.com is owned by CNN. As another example, the website (and each of the webpages on the same server) accessible at http://stanford.edu/˜amitk is managed by user amitk, although Stanford University may own the server that hosts the website. In this example, user amitk is said to be the owner/manager of the website accessible at http://stanford.edu/˜amitk.

A “user group” is a group of users that are associated in some way. A user group may be explicit in that user A registers with user group M and, optionally, pays a group membership fee, for example. The particular user (or optionally a user within the explicit user group) might need to take some active steps for the particular user to join the user group.

A user group may be implicit in that user A frequently visits websites that provide content relating to recent sports news, for example. The implicit user group in this latter example may then consist of all users that frequently visit such websites. An implicit user group may also simply be all users that visit a particular website. The Web activity of a particular user that may cause the particular user to become a member of an implicit user group may also be based on traditional and/or social bookmarking (e.g., tagging, which is described in more detail below) instead of simply the number of visits to a particular website or to related websites. Another example of an implicit group is all users in a particular network and/or behind a particular firewall.

Any mechanism may be used for associating a user with a user group. Embodiments of the invention are not limited to any particular mechanism.

As used herein, in order to be considered “visually distinguishable from each other, two references must be visually distinguishable other than by the text that specifies the URL of the corresponding webpage and any keywords, summary, or abstract associated with the corresponding webpage. Thus, two references may be made visually distinguishable using icons, different background colors, and/or different text formatting, such as text colors, text size, bolding, italicizing, etc.

For example, an icon may be placed adjacent to a reference in order to visually distinguish the reference from other references.

As another example, the background color associated with a reference may be different than the background color associated with other references. In other words, the reference occupies an area, of a SERP, with a background color that is different than the background color of other areas occupied by other references in the SERP.

“Web activity”, of a particular user, may include, but is not limited to, the following: (a) the particular user owning a particular webpage, (b) the particular user bookmarking any webpage of a website to which a particular webpage belongs, (c) the particular user visiting any webpage of a website to which a particular webpage belongs, (d) the particular user tagging any webpage of a website to which a particular webpage belongs, and (e) the particular user otherwise specifying a website or any webpage of a website to which a particular webpage belongs.

The following is an example of a user specifying a webpage or a website. A network administrator of a large company might specify webpages and/or websites that employees of the company are discouraged or prohibited from viewing using company computers. The specified webpages and/or websites are used by the search engine to determine whether any of the references displayed in a SERP should be visually distinguished. In this example, if any of the references in the SERP correspond to webpages and/or websites that the network administrator specified, then those references may be blacked-out or otherwise highlighted or visually distinguished to indicate to the user that the user should not visit the corresponding webpages.

### Tagging

A tag is a keyword or descriptive term associated with an item as a means of classification. Tags are usually chosen informally and personally by a user of the item. For example, a user might discover a webpage that discusses Indian cooking. The user might then create a tag that associates, with the webpage, one or more words such as “Indian cooking”. A tag does not need to be an actual word; rather a tag may consist of any string of one or more characters that a user associates with a webpage.

Thus, tags are not usually part of a formally defined classification scheme. Tags are typically used in dynamic, flexible, automatically generated internet taxonomies for online resources such as computer files, web pages, digital images, and Internet bookmarks. Some users use tags as an alternative to a “bookmark” option provided by the major web browsers.

An item may have one or more tags associated with it, as part of an automated classification software or system. MyWeb (provided by Yahoo!™) and Del.icio.us are popular social bookmarking sites that provide an automated classification system. The system provides links to other items which share a particular tag, or even to specified collections of tags. This allows for multiple “browseable paths” through the items. Such paths can quickly and easily be altered by the collection's administrator with minimal effort and planning.

Thus far, tagging has been “personal” in that tagging has been directed towards end-users who are tagging items for their own use. Tagging also may be directed towards other end-users who are able to use others' tags for their use (e.g. searching across all tags). To extend the “Indian cooking” example, the user-created tag may be made public by allowing other users to search for websites or webpages that discuss “Indian cooking” and by having the URL associated with the “Indian cooking” webpage appear in the search results. Thus, a user may discover related webpages on a per-tag basis. Also, a user may discover multiple tags that have been associated with a particular webpage.

### Ownership

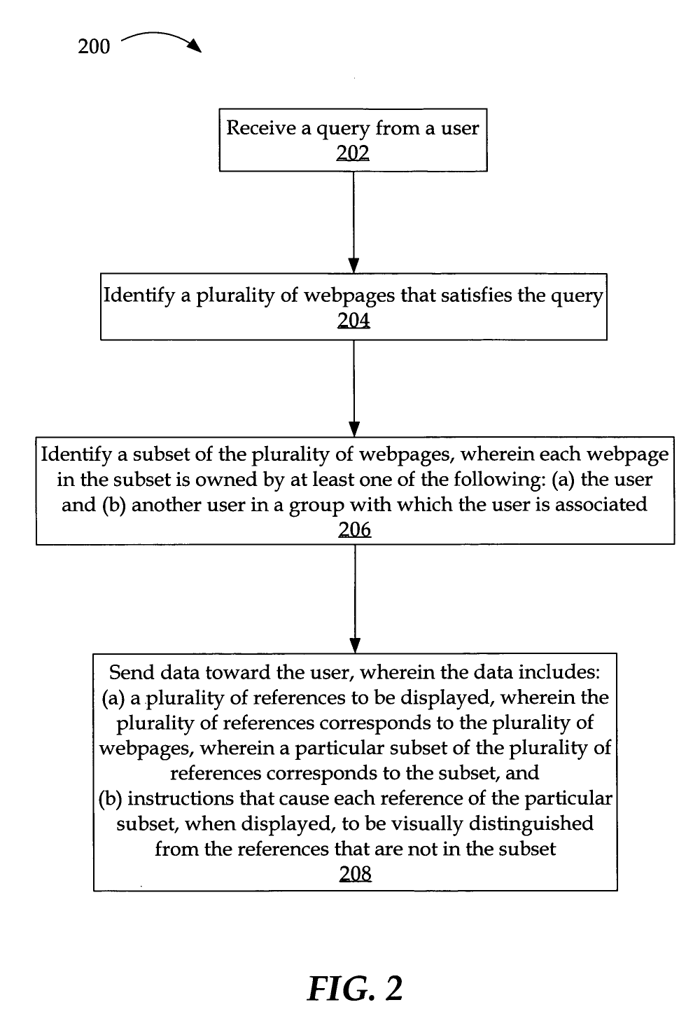

FIG. 2 is a flow diagram 200 that illustrates how ownership of websites by a user or another user in a user group with which the user is associated may be used to visually distinguish references to webpages in a SERP, according to an embodiment of the invention. In step 202, a query is received from a user. In step 204, a plurality of webpages that satisfies the query is identified.

In step 206, a subset of the plurality of webpages is identified. Each webpage in the subset is owned by at least one of the following: (a) the user and (b) another user in a user group with which the user is associated.

In step 208, data is sent toward the user. The data includes a plurality of references that are to be displayed. Each reference of the plurality of references corresponds to a separate webpage of the plurality of webpages. Each reference in a particular subset of the plurality of references corresponds to a separate webpage in the subset of the plurality of webpages identified in step 206 above.

The data sent toward the user also includes instructions that cause each reference of the particular subset, when displayed, to be visually distinguished from the references that are not in the particular subset. The instructions that cause references to be visually distinguishable may be, for example, HTML and/or javascript. Embodiments of the invention are not limited to any particular type of instruction.

In one embodiment, the order in which the plurality of references is displayed is based on whether a particular reference of the plurality of references is also in the particular subset. For example, if one of the references displayed in a SERP is to a webpage owned by the user who submitted the query, then that reference is displayed at the “top” of the list of references.

In one embodiment, step 206 includes identifying a first portion and a second portion of the subset of the plurality of webpages. Each webpage in the first portion is owned by the user and each webpage in the second portion is owned by at least one other user in the user group. The instructions that are sent to the user include further instructions that cause each reference that corresponds to a webpage in the first portion, when displayed, to be visually distinguished from each reference that corresponds to a webpage in the second portion. For example, user A owns webpage P and user B owns webpage R. Users A and B are members of group M. When user A submits a query, a SERP based on the query displays at least webpage P and webpage R, such that the webpage P is visually distinguishable from webpage R.

As a further illustration of embodiments of the invention, all other references, in the SERP, that correspond to webpages that are not owned by user A, or any user in a group associated with user A, have a white background. These references may be the normal search results 102 of FIG. 1. Webpage P (i.e., owned by user A) may be the first highlighted search result 104 of FIG. 1. Webpage R (i.e., owned by user B) may be the second highlighted search result 106 of FIG. 1.

### Gradations

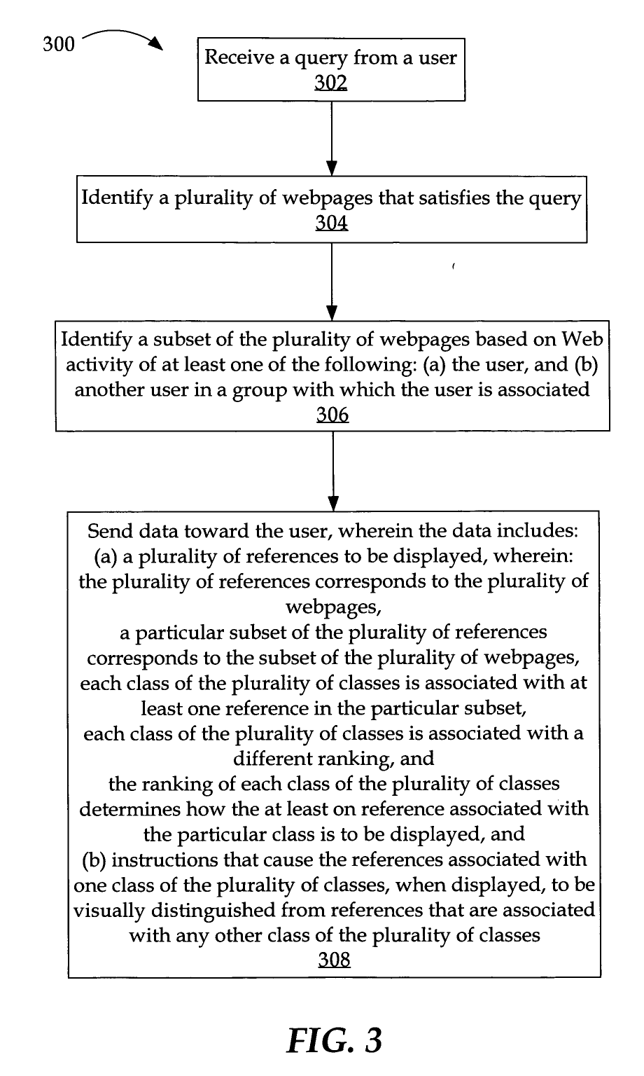

FIG. 3 is a flow diagram 300 that illustrates an example of how results to a query may be displayed in a gradation based on the Web activity of a user or another user in a group with which the user is associated, according to an embodiment of the invention. A gradation is a series forming successive stages. Each stage, referred to below as a “class” may represent an additional level of trust and/or relevance pertaining to references that “belong” to the class.

In step 302, a query is received from a user. In step 304, a plurality of webpages that satisfies the query is identified.

In step 306, a subset of the plurality of webpages is identified based on Web activity of at least one of the following: (a) the user, and (b) another user in a user group with which the user is associated.

In step 308, data is sent toward the user. The data includes a plurality of references to be displayed. The plurality of references corresponds to the plurality of webpages. A particular subset of the plurality of references corresponds to the subset identified above in step 306. Each class of a plurality of classes is associated with at least one different reference in the particular subset. Each class of the plurality of classes is associated with a different ranking. The ranking of each class of the plurality of classes determines how the one or more references associated with the particular class are to be displayed.

The data sent toward the user also includes instructions that cause the references associated with one class of the plurality of classes, when displayed, to be visually distinguished from references that are associated with any other class of the plurality of classes.

For example, user A visits webpage P of website S every weekday. User B owns website T (and all its corresponding webpages). User A submits the query “acme enterprises”, as illustrated in FIG. 1. The second highlighted search result 106 is a reference to a webpage Q of website S (i.e., owned by user A). The first highlighted search result 104 is a reference to a webpage L of website T (i.e., owned by user B). The search engine determines that the two references belong to separate classes with different rankings. Search result 106 may have a higher ranking than search result 104. The higher ranking may indicate that search result 106 may be more trustworthy and/or relevant to user A than search result 104. Accordingly, search result 106 has a background color that is more visually distinguishable from normal search results 102 than the background color of search result 104.

In one embodiment, the ranking of each class indicates a different level of trust. Alternatively or additionally, the ranking may indicate an extra amount of relevancy applied to the reference.

### Website-Webpage Distinction

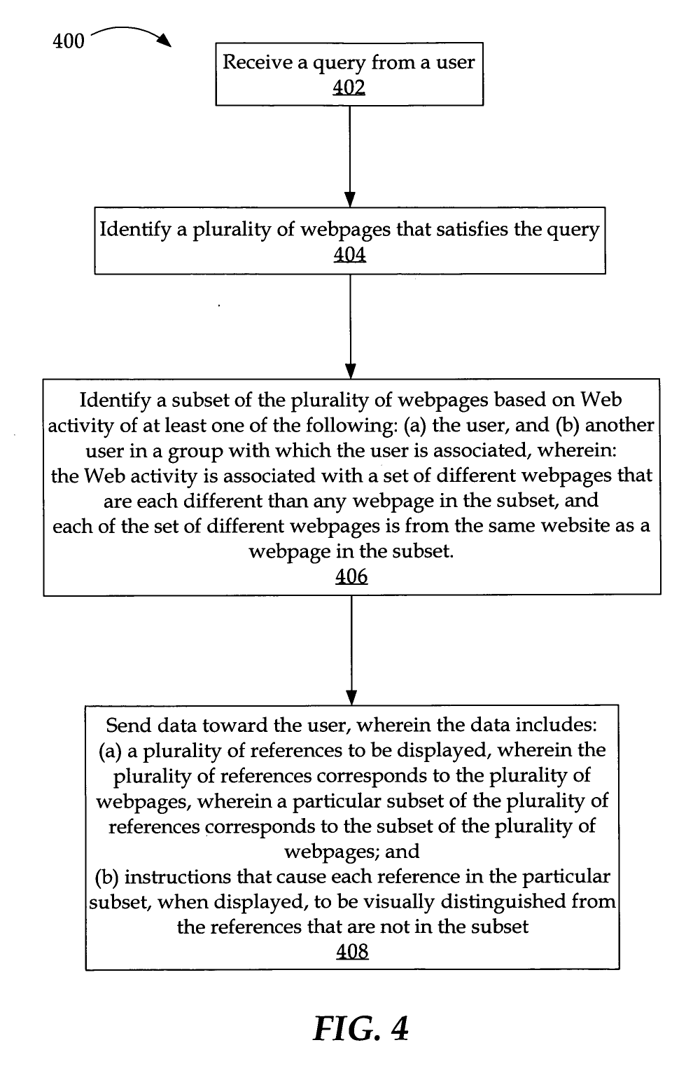

FIG. 4 is a flow diagram 400 that illustrates another example of how results of a query may be displayed based on the Web activity of a user or another user in a user group with which the user is associated, according to an embodiment of the invention. In step 402, a query is received from a user. In step 404, a plurality of webpages that satisfies the query is identified.

In step 406, a subset of the plurality of webpages is identified based on Web activity of at least one of the following: (a) the user, and (b) another user in a user group with which the user is associated. The Web activity of a particular user is associated with a set of different webpages that are each different than any webpage in the subset identified above. Each of the set of different webpages is from the same website as a webpage in the subset.

In step 408, data is sent toward the user. The data includes a plurality of references to be displayed. Each reference of the plurality of references corresponds to a separate webpage of the plurality of webpages. Also, each reference in a particular subset of the plurality of references corresponds to a separate webpage in the subset identified above in step 406.

The data sent toward the user also includes instructions that cause each reference in the particular subset, when displayed, to be visually distinguished from references that are not in the subset.

For example, users A and B are associated with group M. User B associated a tag with webpage P of website S that also comprises webpage R. In response to a query submitted by user A, the search engine identifies webpage R and other webpages that are relevant to the submitted query. Because webpage R belongs to a website (i.e., website S) that comprises a webpage (i.e., webpage P) that user B tagged, the reference to webpage R, when displayed, will be visually distinguishable from other references displayed in a SERP; this, despite the fact that user neither A, nor any user of group M, may have tagged or otherwise interacted with webpage R.

### Hardware Overview

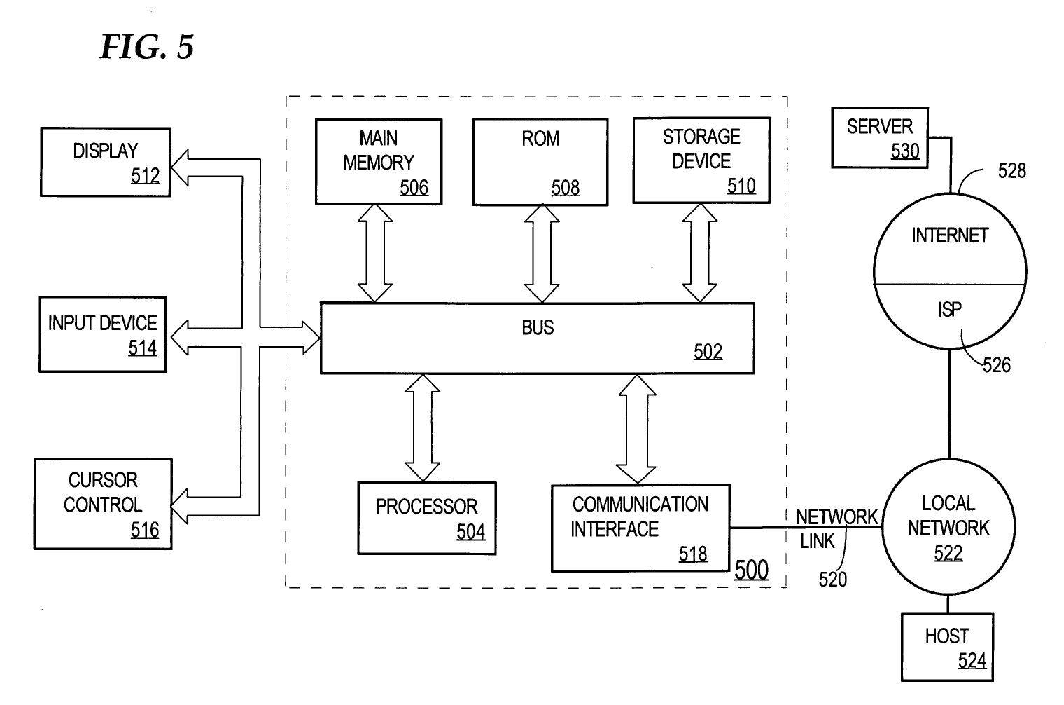

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 500, various machine-readable media are involved, for example, in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method, comprising:
receiving a query from a user;
identifying a plurality of webpages that satisfies said query;
identifying a subset of the plurality of webpages, wherein each webpage in the subset is owned by at least one of the following: (a) the user and (b) another user in a user group with which the user is associated; and
sending data toward the user, wherein the data includes:
(a) a plurality of references to be displayed, wherein each reference of the plurality of references corresponds to a separate webpage of the plurality of webpages, and wherein each reference in a particular subset of the plurality of references corresponds to a different webpage within the subset, and
(b) instructions that cause each reference in the particular subset, when displayed, to be visually distinguished, other than the characters used to describe said each reference, from references that are not in the particular subset.

2. The method of claim 1, wherein an order in which the plurality of references are displayed is based on whether a particular reference of the plurality of references is also in the particular subset.

3. The method of claim 1, wherein:
identifying the subset includes identifying a first portion and a second portion of the subset of the plurality of webpages, wherein each webpage in the first portion is owned by the user and each webpage in the second portion is owned by at least one other user in the group;
said instructions include further instructions that cause each reference that corresponds to a first webpage in the first portion, when displayed, to be visually distinguished from each reference that corresponds to a second webpage in the second portion.

4. The method of claim 1, wherein a first reference of the particular subset is visually distinguished from a second reference of the plurality of references by at least one of the following: (a) an icon that is associated with the first reference and not with the second reference, and (b) a first background color of a first area, of a results page, that is occupied by the first reference is different than a second background color of a second area, of the results page, that is occupied by the second reference.

5. The method of claim 1, wherein:
each class of a plurality of classes is associated with one or more different references in the particular subset;
each class of the plurality of classes is associated with a different ranking;
the ranking of each class of the plurality of classes determines how the one or more different references associated with said each particular class are to be displayed; and
said instructions include further instructions that cause the one or more different references associated with a particular class of the plurality of classes, when displayed, to be visually distinguished, other than the characters used to describe said each reference, from references that are associated with any other class of the plurality of classes.

6. The method of claim 1, wherein:
identifying the subset includes identifying the subset based on Web activity of at least one of said user and said other user;
each particular webpage in the subset corresponds to a separate website;
for each particular website that includes a particular webpage in the plurality of webpages, said Web activity associated with said particular webpage includes at least one of the following:
associating one or more tags with any webpage of said particular website, wherein a tag (a) is a set of one or more words that a particular user associates with a Uniform Resource Locator (URL) and (b) describes content of a webpage that corresponds to the URL;
bookmarking any webpage of said particular website;
visiting any webpage of said particular website; and
specifying any webpage of said particular website in a list of specified webpages.

7. A method, comprising:
receiving a query from a user;
identifying a plurality of webpages that satisfies said query;
identifying a subset of the plurality of webpages based on Web activity of at least one of the following: (a) the user, and (b) another user in a user group with which the user is associated; and
sending data toward the user, wherein the data includes:
(a) a plurality of references to be displayed, wherein:
each reference of the plurality of references corresponds to a separate webpage of the plurality of webpages,
each reference in a particular subset of the plurality of references corresponds to a different webpage in the subset,
each class of a plurality of classes is associated with one or more different references in the particular subset,
each class of the plurality of classes is associated with a different ranking, and
the ranking of each class of the plurality of classes determines how the one or more different references associated with said each class are to be displayed, and
(b) instructions that cause the one or more different references associated with a particular class of the plurality of classes, when displayed, to be visually distinguished, other than the characters used to describe said each reference, from references that are associated with any other class of the plurality of classes.

8. The method of claim 7, wherein:
each particular webpage in the subset corresponds to a separate website;
for each particular website that includes a particular webpage in the plurality of webpages, said Web activity associated with said particular webpage includes at least one of the following:
associating one or more tags with any webpage of said particular website, wherein a tag (a) is a set of one or more words that a particular user associates with a Uniform Resource Locator (URL) and (b) describes content of a webpage that corresponds to the URL;
bookmarking any webpage of said particular website;
visiting any webpage of said particular website; and
specifying any webpage of said particular website in a list of specified webpages.

9. The method of claim 7, wherein the ranking of each class indicates a different level of trust.

10. The method of claim 7, wherein a first reference that is associated with a first class of the plurality of classes is visually distinguished from a second reference that is associated with a second class of the plurality of classes by at least one of the following: (a) an icon that is associated with the first reference and not with the second reference, and (b) a first background color of a first area, of a results page, that is occupied by the first reference is different than a second background color of a second area, of the results page, that is occupied by the second reference.

11. A method, comprising:
receiving a query from a user;
identifying a plurality of webpages that satisfies said query;
identifying a subset of the plurality of webpages based on Web activity of at least one of the following: (a) the user, and (b) another user in a user group with which the user is associated; and
wherein the Web activity is associated with a different webpage that is different than any webpage in the subset;
wherein said different webpage is from the same website as a webpage in the subset;
sending data toward the user, wherein the data includes:
(a) a plurality of references to be displayed, wherein each reference of the plurality of references corresponds to a separate webpage of the plurality of webpages, and wherein each reference in a particular subset of the plurality of references corresponds to a different webpage in the subset; and
(b) instructions that cause each reference in the particular subset, when displayed, to be visually distinguished, other than the characters used to describe said each reference, from references that are not in the particular subset.

12. The method of claim 11, wherein a first reference in the particular subset is visually distinguished from a second reference, of the plurality of references, that is not in the particular subset by at least one of the following: (a) an icon that is associated with the first reference and not with the second reference, and (b) a first background color of a first area, of a results page, that is occupied by the first reference is different than a second background color of a second area, of the results page, that is occupied by the second reference.

13. The method of claim 11, wherein:
each particular webpage in the subset corresponds to a separate website;
for each particular website that includes a particular webpage in the plurality of webpages, said Web activity associated with said particular webpage includes at least one of the following:
associating one or more tags with any webpage of said particular website, wherein a tag (a) is a set of one or more words that a particular user associates with a Uniform Resource Locator (URL) and (b) describes content of a webpage that corresponds to the URL;
bookmarking any webpage of said particular website;
visiting any webpage of said particular website; and
specifying any webpage of said particular website in a list of specified webpages.

14. The method of claim 11, wherein:
each class of a plurality of classes is associated with one or more different references in the particular subset;
each class of the plurality of classes is associated with a different ranking;
the ranking of each class of the plurality of classes determines how the one or more different references associated with said each class are to be displayed; and
said instructions include further instructions that cause the one or more different references associated with a particular class of the plurality of classes, when displayed, to be visually distinguished, other than the characters used to describe said each reference, from references that are associated with any other class of the plurality of classes.

15. A computer-readable medium carrying one or more sequences of instructions which, when executed by one or more processors, causes the one or more processors to perform the method recited in claim 1.

16. A computer-readable medium carrying one or more sequences of instructions which, when executed by one or more processors, causes the one or more processors to perform the method recited in claim 2.

17. A computer-readable medium carrying one or more sequences of instructions which, when executed by one or more processors, causes the one or more processors to perform the method recited in claim 3.

18. A computer-readable medium carrying one or more sequences of instructions which, when executed by one or more processors, causes the one or more processors to perform the method recited in claim 4.

19. A computer-readable medium carrying one or more sequences of instructions which, when executed by one or more processors, causes the one or more processors to perform the method recited in claim 5.

20. A computer-readable medium carrying one or more sequences of instructions which, when executed by one or more processors, causes the one or more processors to perform the method recited in claim 6.

21. A computer-readable medium carrying one or more sequences of instructions which, when executed by one or more processors, causes the one or more processors to perform the method recited in claim 7.

22. A computer-readable medium carrying one or more sequences of instructions which, when executed by one or more processors, causes the one or more processors to perform the method recited in claim 8.

23. A computer-readable medium carrying one or more sequences of instructions which, when executed by one or more processors, causes the one or more processors to perform the method recited in claim 9.

24. A computer-readable medium carrying one or more sequences of instructions which, when executed by one or more processors, causes the one or more processors to perform the method recited in claim 10.

25. A computer-readable medium carrying one or more sequences of instructions which, when executed by one or more processors, causes the one or more processors to perform the method recited in claim 11.

26. A computer-readable medium carrying one or more sequences of instructions which, when executed by one or more processors, causes the one or more processors to perform the method recited in claim 12.

27. A computer-readable medium carrying one or more sequences of instructions which, when executed by one or more processors, causes the one or more processors to perform the method recited in claim 13.

28. A computer-readable medium carrying one or more sequences of instructions which, when executed by one or more processors, causes the one or more processors to perform the method recited in claim 14.
